(19) United States
(12) Patent Application Publication
(10) Pub. No.: US 2011/0292314 A1
(43) Pub. Date: Dec. 1, 2011

(54) DISPLAY APPARATUS AND BACKLIGHT MODULE

(75) Inventors: Peng-Fang Chen, Hsin-Chu (TW); Shang-Chia Liu, Hsin-Chu (TW); Fan-Ti Cho, Hsin-Chu (TW); Lei-Ken Hung, Hsin-Chu (TW)

(73) Assignee: YOUNG LIGHTING TECHNOLOGY CORPORATION, Hsin-Chu (TW)

(21) Appl. No.: 13/014,721

(22) Filed: Jan. 27, 2011

(30) Foreign Application Priority Data
Jun. 1, 2010 (CN) 201020216275.6

(51) Int. Cl. G02F 1/1333

(52) U.S. Cl. 349/58

(57) ABSTRACT

A display apparatus and a backlight module are provided. The display apparatus includes a liquid crystal panel and a backlight module. The backlight module includes a frame, a plurality of latch members, and a backlight source. The frame has a receiving slot. The liquid crystal panel is disposed in the receiving slot. The latch members are disposed on the frame and located at an inner wall of the receiving slot. The latch members support the liquid crystal panel. A material of each latch member is a debris-resistant material. The backlight source is disposed on the frame and located at one side of the liquid crystal panel. The invention may prevent the producing of debris when the latch members and the liquid crystal panel are rubbed against each other.

### CROSS-REFERENCE TO RELATED APPLICATION

This application claims the priority benefit of China application serial no. 201020216275.6, filed on Jun. 1, 2010. The entirety of the above-mentioned patent application is hereby incorporated by reference herein and made a part of this specification.

### BACKGROUND OF THE INVENTION

1. Field of the Invention

The invention relates to a display apparatus and a backlight module, and more particularly, to a liquid crystal display apparatus and a backlight module thereof

2. Description of Related Art

Following the ever increasing advancement in the electronics industry, flat panel displays have gradually replaced cathode ray tube (CRT) displays and become the main stream in the market. Among various types of flat panel displays, liquid crystal display is the most mature technology and is also most popularized. However, a liquid crystal panel for the liquid crystal display does not emit light by itself. Therefore, a backlight module acting as a light source is disposed below the liquid crystal display panel to achieve the displaying function. The backlight module may include a frame having a receiving slot, and the liquid crystal panel may be disposed in the receiving slot of the frame so as to be positioned in the backlight module. Specifically, the frame may include a plurality of latch members at an inner wall of the receiving slot. The latch members are used to support and hence position the liquid crystal panel.

A gap is generally formed between the latch members and the liquid crystal panel for ease of assembly. Therefore, when the display apparatus is subject to shock during transportation or due to other reasons, each latch member and the liquid crystal panel may be rubbed against each other, causing the latch members to produce debris falling onto the surface of the liquid crystal panel, thus degrading the displaying quality of the display apparatus.

China Taiwan Patent Application Publication No. 200904881 discloses a rub-resistant protective pad material. China Taiwan Patent Application Publication No. 200921196 discloses the technique of preventing the backlight module from producing debris due to rubbing during assembly by affixing a protective film. China Taiwan Patent No. M304048 discloses a backlight module, wherein a soft protective member is used to prevent scratch and debris from being formed on the optical film and light guide plate during assembly. China Taiwan Patent Application Publication No. 200831988 discloses a liquid crystal display having a frame with protrusions. Contact between the protrusions and the diffusion plate may reduce the friction and scratch between the frame and the diffusion plate.

### SUMMARY OF THE INVENTION

Accordingly, the invention is directed to a display apparatus, and the display apparatus may prevent producing of debris when latch members and a liquid crystal panel are rubbed against each other.

The invention is also directed to a backlight module, and the backlight module may prevent producing of debris when latch members and a liquid crystal panel are rubbed against each other.

Other objects and advantages of the invention may be further illustrated by the technical features broadly embodied and described as follows.

An embodiment of the invention provides a display apparatus including a liquid crystal panel and a backlight module. The backlight module includes a frame, a plurality of latch members, and a backlight source. The frame has a receiving slot. The liquid crystal panel is disposed in the receiving slot. The latch members are disposed on the frame and located at an inner wall of the receiving slot. The latch members support the liquid crystal panel. A material of each of the latch members is a debris-resistant material. The backlight source is disposed on the frame and located at one side of the liquid crystal panel.

According to one embodiment of the display apparatus, the receiving slot is a rectangular slot, the latch members include four pairs of latch members, and the four pairs of the latch members are respectively positioned adjacently to four corners of the rectangular slot.

According to one embodiment of the display apparatus, each pair of the latch members are located at different sides of the rectangular slot.

According to one embodiment of the display apparatus, the material of the latch member is different from a material of the frame.

According to one embodiment of the display apparatus, the material of the latch member includes at least one of poly carbonate, glass fiber, nylon, polypropylene, nitrile butadiene rubber, and thermo-plastic polyurethane.

According to one embodiment of the display apparatus, the latch member is mounted to the frame in a snap-fit manner, with screws or with adhesive, or the latch member is integrally formed with the frame.

According to one embodiment of the display apparatus, the backlight source is a direct type backlight source or a side type backlight source.

In another aspect, an embodiment of the invention provides a backlight module adapted to a display apparatus. The display apparatus includes a liquid crystal panel. The backlight module includes a frame, a plurality of latch members, and a backlight source. The frame has a receiving slot. The liquid crystal panel is disposed in the receiving slot. The latch members are disposed on the frame and located at an inner wall of the receiving slot. The latch members support the liquid crystal panel. A material of each of the latch members is a debris-resistant material. The backlight source is disposed on the frame and located at one side of the liquid crystal panel.

According to one embodiment of the backlight module, the receiving slot is a rectangular slot, the latch members includes four pairs of latch members, and the four pairs of the latch members are respectively positioned adjacently to four corners of the rectangular slot.

According to one embodiment of the backlight module, each pair of the latch members are located at different sides of the rectangular slot.

According to one embodiment of the backlight module, the material of the latch member is different from a material of the frame.

According to one embodiment of the backlight module, the material of the latch member includes at least one of poly carbonate, glass fiber, nylon, polypropylene, nitrile butadiene rubber, and thermo-plastic polyurethane.

According to one embodiment of the backlight module, the latch member is mounted to the frame in a snap-fit manner, with screws or with adhesive, or the latch member is integrally formed with the frame.

According to one embodiment of the backlight module, the backlight source is a direct type backlight source or a side type backlight source.

In summary, the embodiment or the embodiments of the invention may have at least one of the following advantages:

In the above embodiments of the invention, the material of the latch member is a debris-resistant material. Therefore, each of the latch members may be prevented from producing debris falling onto the liquid crystal panel thus ensuring a good displaying quality of the display apparatus when the liquid crystal panel and the latch members are rubbed against each other.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a top view of a display apparatus according one embodiment of the invention.

FIG. 2 is an enlarged view of a circled area A of the display apparatus of FIG. 1.

FIG. 3 is an exploded view of the display apparatus of FIG. 1.

FIG. 4 is an enlarged view of a circled area B of the display apparatus of FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

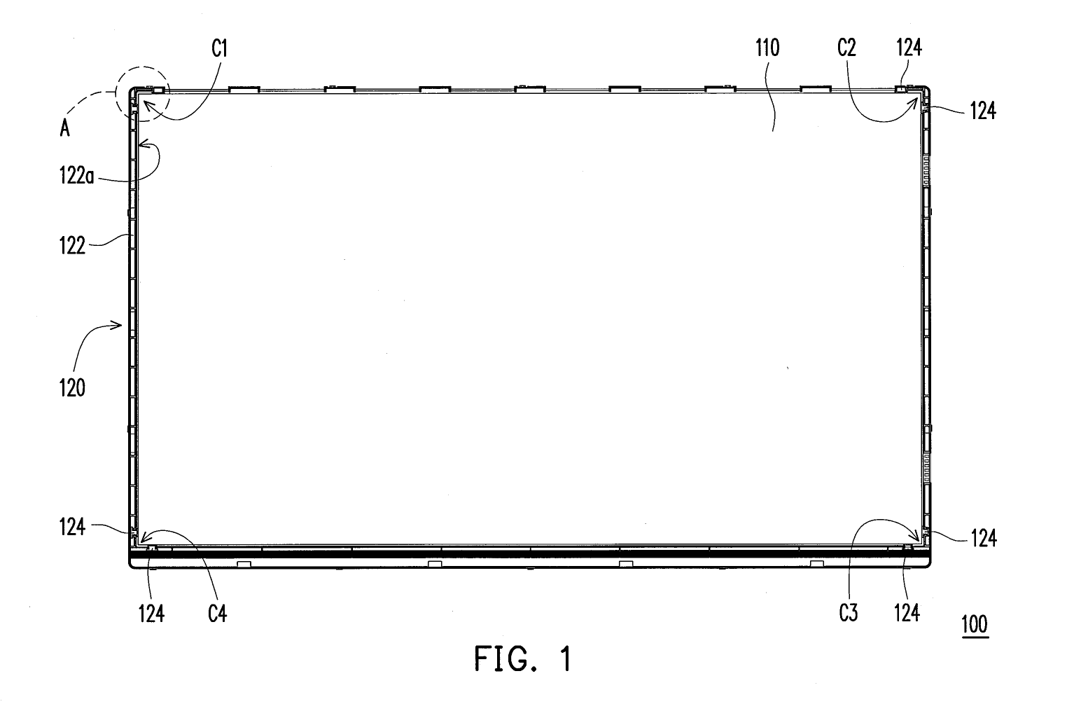

Referring to FIGS. 1 to 4, the display apparatus 100 of the present embodiment includes a liquid crystal panel 110 and a backlight module 120. The backlight module 120 includes a frame 122, a plurality of latch members 124, and a backlight source 126. The frame 122 has a receiving slot 122a, and the liquid crystal panel 110 is disposed into the receiving slot 122a. The backlight module 126 is disposed on the frame 122 and located at one side of the liquid crystal panel 110 to illuminate the liquid crystal panel 110.

In the present embodiment, the latch members 124 are disposed on the frame 122 and located at an inner wall of the receiving slot 122a to support the liquid crystal panel 110. Each of the latch members 124 is made from a debris-resistant material, such that, the latch member 124 may be prevented from producing debris falling onto the liquid crystal panel 110 when the liquid crystal panel 110 and the latch member 124 are rubbed against each other, thus ensuring a good displaying quality of the display apparatus 100.

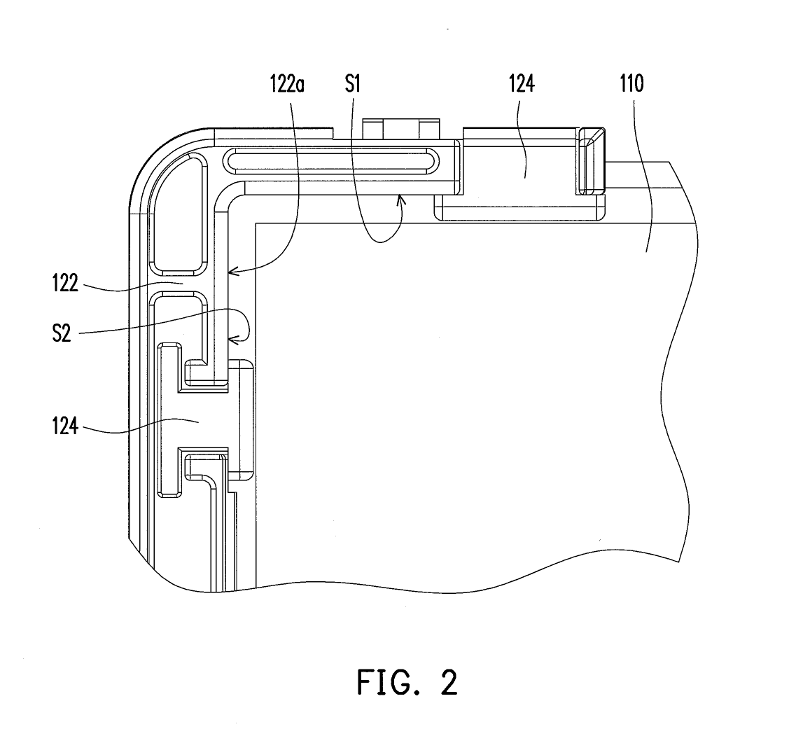

In particular, in the present embodiment, the receiving slot 122a is a rectangular slot. The latch members 124 include four pairs of the latch members 124. The four pairs of the latch members 124 are respectively positioned adjacently to a corresponding one of four corners C1, C2, C3, and C4 of the rectangular slot (receiving slot) 122a, and the two latch members 124 of the each pair of the latch members 124 are positioned at different sides (e.g. the side S1 and the side S2 of FIG. 2) of the rectangular slot (receiving slot) 122a to stably position the liquid crystal panel 110. In addition, a material of the latch member 124 may be different from a material of the frame 122. For example, the material of the latch member 124 may be debris-resistant material such as poly carbonate (PC), glass fiber (GF), nylon, polypropylene (PP), nitrile butadiene rubber (NBR), or thermo-plastic polyurethane (TPU).

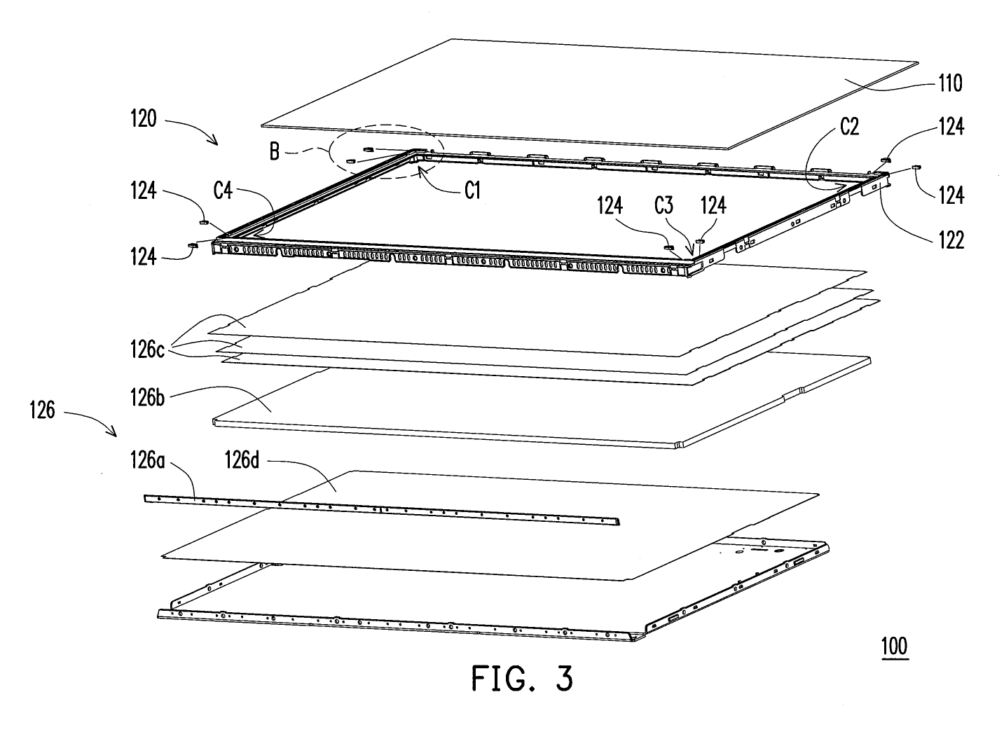

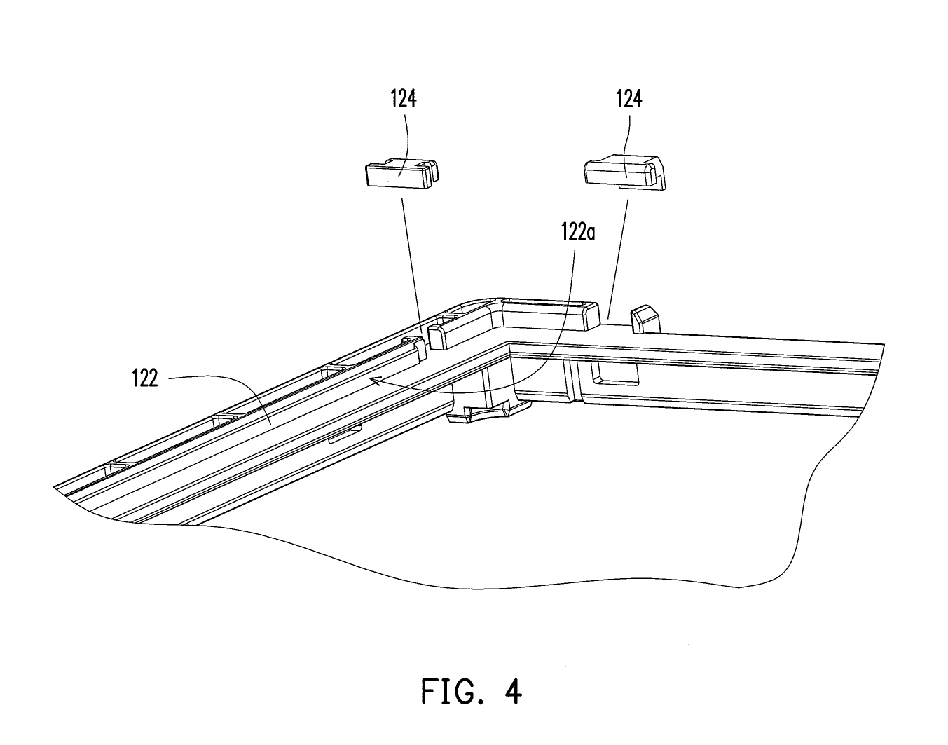

In the present embodiment, the latch member 124 is mounted to the frame 122 in a snap-fit manner. However, this should not be regarded as limiting. In alternative embodiments, the latch member 124 may be mounted to the frame 122 with screws or adhesive, or the latch member 124 may be integrally formed with the frame 122 by co-injection molding or ultrasonic welding. Noticeably, each of the latch members 124 is illustrated as being separated from the frame 122 in FIG. 3 and FIG. 4. Besides, each of the latch members 124 is illustrated as being mounted to the frame 122 to support the liquid crystal panel 110 in FIG. 1 and FIG. 2.

Referring to FIG. 3, the backlight source 126 of the present embodiment is, for example, a side type backlight source. In particular, the backlight source 126 includes a light emitting diode strip 126a, a light guide plate 126b, a plurality of optical sheets 126c, and a reflective sheet 126d. Light emitted by the light emitting diode strip 126a is transmitted through the light guide plate 126b to illuminate the liquid crystal panel 110. However, this should not be regarded as limiting. Rather, in alternative embodiments, the backlight source 126 may also be a direct type backlight source.

In summary, the embodiment or the embodiments of the invention may have at least one of the following advantages:

In embodiments of the invention, the material of the latch member is a debris-resistant material. Therefore, the latch member may be prevented from producing debris falling onto the liquid crystal panel when the liquid crystal panel and the latch members are rubbed against each other, thus ensuring a good displaying quality of the display apparatus. In addition, the receiving slot of the frame may be a rectangular slot. The latch members may include four pairs of the latch members. The four pairs of the latch members are positioned adjacently to four corners of the receiving slot, and each the pair of the latch members are positioned at different sides of the receiving slot to stably position the liquid crystal panel.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A display apparatus comprising:
a liquid crystal panel; and
a backlight module comprising:
a frame having a receiving slot, wherein the liquid crystal panel is disposed in the receiving slot;
a plurality of latch members, disposed on the frame, located at an inner wall of the receiving slot, and supporting the liquid crystal panel, wherein a material of each of the latch members is a debris-resistant material; and
a backlight source disposed on the frame and located at one side of the liquid crystal panel.

2. The display apparatus according to claim 1, wherein the receiving slot is a rectangular slot, the latch members comprise four pairs of latch members, and the four pairs of the latch members are respectively positioned adjacently to four corners of the rectangular slot.

3. The display apparatus according to claim 2, wherein each pair of the latch members are located at different sides of the rectangular slot.

4. The display apparatus according to claim 1, wherein the material of the latch member is different from a material of the frame.

5. The display apparatus according to claim 1, wherein the material of the latch member comprises at least one of poly carbonate, glass fiber, nylon, polypropylene, nitrile butadiene rubber, and thermo-plastic polyurethane.

6. The display apparatus according to claim 1, wherein the latch member is mounted to the frame in a snap-fit manner, with screws or with adhesive, or the latch member is integrally formed with the frame.

7. The display apparatus according to claim 1, wherein the backlight source is a direct type backlight source or a side type backlight source.

8. A backlight module adapted to a display apparatus comprising a liquid crystal panel, wherein the backlight module comprises:
a frame having a receiving slot, wherein the liquid crystal panel is disposed in the receiving slot;
a plurality of latch members, disposed on the frame, located at an inner wall of the receiving slot, and supporting the liquid crystal panel, wherein a material of each of the latch members is a debris-resistant material; and
a backlight source disposed on the frame and located at one side of the liquid crystal panel.

9. The backlight module according to claim 8, wherein the receiving slot is a rectangular slot, the latch members comprise four pairs of latch members, and the four pairs of the latch members are respectively positioned adjacently to four corners of the rectangular slot.

10. The backlight module according to claim 9, wherein each pair of the latch members are located at different sides of the rectangular slot.

11. The backlight module according to claim 8, wherein the material of the latch member is different from a material of the frame.

12. The backlight module according to claim 8, wherein the material of the latch member comprises at least one of poly carbonate, glass fiber, nylon, polypropylene, nitrile butadiene rubber, and thermo-plastic polyurethane.

13. The backlight module according to claim 8, wherein the latch member is mounted to the frame in a snap-fit manner, with screws or with adhesive, or the latch member is integrally formed with the frame.

14. The backlight module according to claim 8, wherein the backlight source is a direct type backlight source or a side type backlight source.
